(19) United States
(12) Patent Application Publication
(10) Pub. No.: US 2026/0100823 A1
(43) Pub. Date: Apr. 9, 2026

(54) Offloading the Secure Communication Transport Protocol Session Key Negotiation and Establishment to a Remote Service/Server

(71) Applicant: DigiCert, Inc., Lehi, UT (US)

(72) Inventors: Atul Gupta, Cupertino, CA (US); Shrey Tandel, San Jose, CA (US)

(73) Assignee: DigiCert, Inc., Lehi, UT (US)

(21) Appl. No.: 18/910,367

(22) Filed: Oct. 9, 2024

(51) Int. Cl. H04L 9/08; H04L 9/32; H04L 9/40

(52) U.S. Cl. CPC H04L 9/0838; H04L 9/0852; H04L 9/32; H04L 63/029

(57) ABSTRACT

A method to be performed at Secure Key Service (SKS) includes, responsive to a need to establish a secure tunnel between a device and a peer device receiving a request to offload authentication and session key negotiation for a Post-Quantum Cryptography (PQC) encryption algorithm from the device performing the authentication and session key negotiation with the peer device, and providing a key for the PQC encryption algorithm from the session key negotiation to the device, for use in data exchange with the peer device via the secure tunnel.

### FIELD OF THE DISCLOSURE

The present disclosure generally relates to computing. More particularly, the present disclosure relates to systems and methods for offloading computationally intensive stages for constrained devices to co-located servers within a similar network.

### BACKGROUND OF THE DISCLOSURE

Device connectivity is expanding rapidly across various platforms, including general-purpose computing devices like laptops, servers, desktop computers, mobile phones, and tablets. In addition to these, there is a distinct category of embedded devices, such as Internet-of-Things (IoT) devices, which also include processors, memory, and network interfaces. However, unlike general-purpose devices, embedded devices are typically designed to perform specific, focused functions, leading to constraints such as limited processing power, memory, size, power consumption, and battery life. For example, a tracker tag is a constrained device dedicated to providing location information, with its design emphasizing minimal processing and memory usage to maximize battery life. In contrast, a laptop or mobile phone can perform multiple tasks and is built to accommodate higher processing power and memory at the cost of frequent recharging.

Implementing Post-Quantum Cryptography (PQC) for authentication and session key negotiation will eventually become a requirement as the current cryptographic standards, such as Rivest-Shamir-Adleman (RSA) and Elliptic-curve cryptography (ECC), will no longer be safe against quantum computers. However, upgrading all legacy and constrained devices to support PQC encryption is impractical due to the computational demands of these algorithms. A secure tunnel, such as that used in protocols like Hypertext transfer protocol secure (HTTPS) (e.g., using Transport Layer Security (TLS)/Secure Sockets Layer (SSL)), requires these cryptographic processes to ensure safe data transmission. Replacing all constrained devices to accommodate PQC encryption is an expensive and logistically difficult solution. Therefore, there exists a need for alternatives to authentication and session key negotiation that can facilitate the adoption of quantum-safe algorithms without necessitating widespread hardware replacement, particularly in constrained environments where devices are not equipped to handle the increased computational load required by PQC encryption.

### BRIEF SUMMARY OF THE DISCLOSURE

The present disclosure relates to systems and methods for offloading a secure communication transport protocol session key and establishing a remote server. The methods provided herein can include utilizing a Session Key Service (SKS) and allow a resource which is constrained (i.e., constrained by memory and/or CPU processor power) to utilize a PQC and/or strong cryptographic algorithms for authorization and key establishment. Moreover, the method can offload the high demand tasks to the SKS. The SKS can perform a full handshake with the Peer Secure server and can allow the negotiation of a Session information/ticket on the device's behalf. This can be shared with the resource constrained device via a secure channel. The shared negotiated key/session information can allow the constrained device to establish a direct secure communication with the remote service. Advantageously, the methods herein do not introduce any additional hops during the data transport.

As disclosed herein, the device can require the establishment of a secure connection with a remote server. The device can request the SKS to negotiate the authentication and key exchange on, for example, behalf of the device. The SKS can include an SKS flow which does not require the device to proxy the traffic. The SKS can communicate directly with the remote service. As such, the methods described herein do not introduce any additional hops during the data transport.

One aspect of the present disclosure pertains to a method performed at a Security Key Service (SKS) which includes responsive to a need to establish a secure connection between a device and a peer device, receiving a request to offload authentication and session key negotiation for a Post-Quantum Cryptography (POC) encryption algorithm from the device, performing the authentication and session key negotiation with the peer device, and providing a key for the PQC encryption algorithm from the session key negotiation to the device, for use in data exchange with the peer device via the secure tunnel.

In a further aspect, disclosed is a method performed at a device including responsive to a need to establish a secure tunnel between the device and a peer device, requesting to offload authentication and session key negotiation for a Post-Quantum Cryptography (PQC) encryption algorithm from the device to an Security Key Service (SKS), responsive to the SKS performing the authentication and session key negotiation with the peer device, receiving a key from the PQC encryption algorithm, and exchanging data with the peer device over the secure tunnel using the key.

In a yet further aspect, disclosed is a constrained device including a processor, and a memory storing program code that is configured to cause the processor to: responsive to a need to establish a secure tunnel between a device and a peer device, receive a request to offload authentication and session key negotiation for a PQC encryption algorithm from the device, perform the authentication and session key negotiation with the peer device, and provide a key for the PQC encryption algorithm from the session key negotiation to the device, for use in data exchange with the peer device via the secure tunnel.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram of a constrained device.

FIG. 2 is a process for generating private keys for quantum-safe algorithms on constrained devices.

FIG. 3 is a flowchart for generating a secure tunnel.

FIG. 4 is a process for offloading a secure communication transport protocol session key negotiation and establishment to a remote server.

### DETAILED DESCRIPTION OF THE DISCLOSURE

Again, the present disclosure relates to systems and methods for offloading computationally intensive states of TLS or other PQC techniques for constrained devices, such as IoT devices. Traditional TLS involves a multi-stage approach, such as a three state approach for authentication, key negotiation, and data transmissions. In typical aspects, the disclosure provides systems and methods configured to offload these stages to a co-located server within the same network. Advantageously, the server can be configured to handle authentication and key negotiation on behalf of the constrained device. Subsequently, the server can be configured to securely transfer the negotiated session key back to the device for direct data transmission. The use of a secure connection between the server and the device is emphasized and is essential to prevent vulnerabilities during key exchange.

As such, the architecture of the present disclosure can avoid the traditional proxy model where data is relayed through a server in a separate network. The server of the present disclosure is strictly limited to establishing the session, while the constrained device maintains direct communication with the end peer. Advantageously, in such approach, the server is not responsible for handling data transmission which results in a reduced computational load and avoids unnecessary data relays. In some examples, the server can be an edge gateway, a modem, or any high-powered device in the network, such as a mobile phone. The use of any high-powered device can be critical in networks which communicate with a plurality of sensors, such as factories or hospitals where resources on individual devices are limited, but Post-Quantum Cryptography (PQC) might be required.

In other aspects, the present disclosure incorporates the PQC algorithms on a centralized server without the need to update each constrained device. Once the session key is negotiated, the device can be configured to operate using the key without requiring updates to handle new algorithms. Moreover, the systems of the present disclosure can be configured to extend to “Brownfield” devices, which can be existing devices in the field. Such extension to Brownfield devices can allow enterprises to offload PQC computations to a single new device rather than replacing all existing devices. Advantageously, this can reduce the cost and complexity of managing security updates across numerous IoT devices in large networks.

### Example Constrained Device Architecture

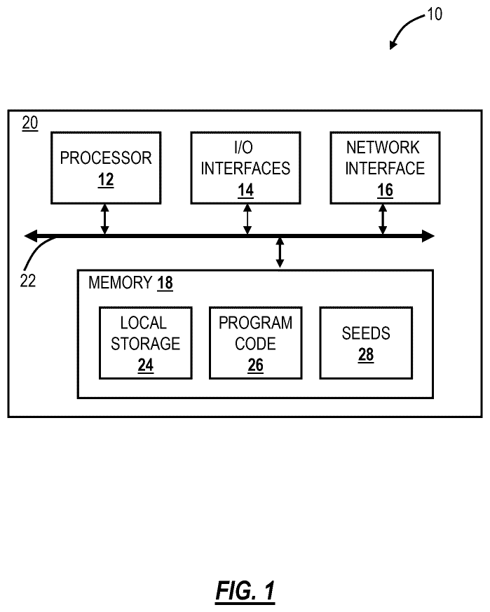

FIG. 1 is a block diagram of a constrained device 10. The constrained device 10 may be a digital computing device that, in terms of hardware architecture, generally includes a processor 12, input/output (I/O) interfaces 14, a network interface 16, a data store 308, and memory 18, which can be contained in a housing 20. The components (12, 14, 16, 18) are communicatively coupled via a local interface 22. The local interface 22 may be, for example, but not limited to, one or more buses or other connections, as is known in the art. The local interface 22 may have additional elements, which are omitted for simplicity, such as controllers, buffers (caches), drivers, repeaters, and receivers, among many others, to enable communications. Further, the local interface 22 may include address, control, and/or data connections to enable appropriate communications. It should be appreciated by those skilled in the art that FIG. 1 depicts the constrained device 10 in an oversimplified manner, and a practical embodiment may include additional components and suitably configured processing logic to support known or conventional operating features that are not described in detail herein, such as, e.g., power, a battery, etc. Also, those skilled in the art will appreciate the components in FIG. 1 are a functional representation and practical embodiments may include integration of the functions in circuitry. Those skilled in the art will appreciate the constrained device 10 is presented as an example architecture for illustration purposes and other approaches are contemplated.

The processor 12 is a hardware device for executing software instructions. The processor 12 may be any custom made or commercially available processor, a Central Processing Unit (CPU), an auxiliary processor among several processors associated with the constrained device 10, a microcontroller, a semiconductor-based microprocessor (in the form of a microchip or chipset), or generally any device for executing software instructions. When the constrained device 10 is in operation, the constrained device 10 is configured to execute instructions stored within the memory 18, to communicate data to and from the memory 18, and to generally control operations of the constrained device 10 pursuant to the instructions. Again, a constrained device 10 is not a general-purpose computing device, but one focused on one or more specific functions. The processor 12 does not necessarily have to support general purpose operation, but can be configured to only support the one or more specific functions.

The I/O interfaces 14 may be used to receive input from and/or for providing output. In the constrained device 10, unlike a general-purpose computing device, does not usually have a touch screen, keyboard, mouse, etc., but rather I/O directed towards the one or more specific functions, such as visual indicators (e.g., Light Emitting Diodes (LEDs)), buttons, a display for displaying information related to the one or more specific functions, and the like. The network interface 16 is used to enable the constrained device 10 to communicate on a network, such as the Internet. The network interface 16 may include, for example, an Ethernet card or adapter or a Wireless Local Area Network (WLAN) card or adapter. The network interface 16 may include address, control, and/or data connections to enable appropriate communications on the network. For example, the network interface 16 can support Wi-Fi, Bluetooth, Bluetooth Low Energy (BLE), other types of wireless protocols, and combinations thereof.

The memory 18 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 18 may incorporate electronic, magnetic, optical, and/or other types of storage media. Note that the memory 18 may have a distributed architecture, where various components are situated remotely from one another but can be accessed by the processor 18. The memory 18 is configured to store data such as in local storage 24, program code 26, and seeds 28. Note, the local storage 24, the program code 26, and the seeds 28 can be stored in the same physical memory hardware and are described logically. The program code 26 includes executable instructions for implementing logical functions to support the one or more specific functions. The program code 26 may include instructions configured to implement the various processes, algorithms, methods, techniques, etc. described herein. The local storage 24 can store data related to ongoing operation of the one or more specific functions. Finally, the seeds 28 represent constituent parts of a private key for the constrained device 10. The private key is associated with a quantum-safe algorithm. That is, the private key itself is not stored in the memory 18, but rather the seeds 28, and the program code 26 is configured to generate the private key as needed.

### Example Constrained Devices and Private Key Applications

As described herein, the constrained device 10 can be an embedded device, an IoT device, a sensor, or the like. The private key is used to secure operations associated with the constrained device 10, such as for communications to cloud services and the like. The private key is used for device identity, device enrollment in services, secure booting, authentication, encryption in communications, provisioning, software updates, and the like. That is, the private key is utilized occasionally, but not ongoing at all times of operation of the constrained device 10. Accordingly, there is not a need to keep the private key stored in the memory 18 all the time, but only on demand as needed.

According to one example, the constrained device 10 may be within a kitchen appliance (e.g., refrigerator) for initially uploading registration information about the kitchen application (e.g., serial number, model number, purchaser information, etc.) when this product is first plugged in and connected online. Also, according to this example, the constrained device 10 may convey operating conditions of the kitchen appliance to the cloud-based server in order to allow the cloud-based server to monitor, for example, whether maintenance may be required on the host device. In this example, the kitchen appliance may include a large population of existing devices, having constraints in the memory 18, so that it is not possible to efficiently store a private key for the quantum-safe algorithms that is significantly larger than a private key for existing symmetric or asymmetric algorithms. That is, it may be possible to increase the size of the memory 18 in new kitchen appliances, but it is not possible to do so for a large population of existing devices.

According to another example, the constrained device 10 may include a tracker tag which is a small, battery-powered device configured to attach to devices for location determination. For example, the tracker tag can use BLE, ultra-wideband (UWB), etc. to respond to location requests. The tracker tags may be affixed to practically anything, e.g., backpacks, luggage, keys, etc. The tracker tags may use the private key to authenticate communications. For user output, the tracker tags may be configured to play a sound on demand as well as respond over a network to cloud services with a location, e.g., Global Position Satellite (GPS) coordinates, and the like. In this example, it may be possible to scale the memory 18 size in new tracker tags, but having larger memory 18 may result in higher power consumption which is undesirable. That is, reducing the memory 18 usage supports longer battery life.

### Digital Trust With the Constrained Device

The private key on the constrained device 10 is used for various aspects of digital trust with the constrained device 10. The private key is preconfigured on the constrained device 10, such as in manufacturing, assembly, etc. Another service, such as a cloud service configured to communicate with the constrained device 10 has a corresponding public key which is used to encrypt any communications to the constrained device 10. The constrained device 10 uses the private key to decrypt the communications that were encrypted via the public key.

### Conventional Encryption Algorithms

Again, the existing approaches use either asymmetric or symmetric algorithms, such as RSA, ECC, AES, etc. The private key lengths can be 2048 bits (RSA 2048), 521 bits (ECC 521), 256 bits (AES 256), etc. These existing approaches use hard mathematical problems, such as the integer factorization problem, the discrete logarithm problem or the elliptic-curve discrete logarithm problem. Using existing computers, these hard mathematical problems are extremely difficult to attack. However, newly emerging quantum computers will be able to break these existing algorithms. To that end, there is ongoing work and standardization of so-called quantum-safe algorithms.

### Quantum-safe Algorithms

The present disclosure utilizes the term quantum-safe algorithms to refer to algorithms which are secure to attacks by a quantum computer. Other terms include post-quantum-safe algorithms, quantum-resistant, etc. Again, the problem with quantum computers and the existing approaches above is they rely on the hard mathematical problems which are easily solved on a sufficiently powerful quantum computer.

To that end, quantum-safe algorithms focus on different approaches which are summarized as follows. Of note, all of these quantum-safe algorithms have private keys which are significantly larger in size than the private keys size in the existing approaches which at most are a couple hundred bits. With quantum-safe algorithms, the private key sizes can range close to a kilobyte to several kilobytes or more. Thus, the memory 18 requirements can be one or more orders of magnitude greater to store the private key for quantum-safe algorithms than for existing algorithms.

Quantum-safe algorithms can be lattice-based, hash-based, code-based, multivariate-based, isogeny-based, and the like. The present disclosure contemplates any of these quantum-safe algorithms. Note, in all of these quantum-safe algorithms, the private key is generated based on some operations on seeds. That is, the private key can be a product of some operations involving seeds. As described herein, seeds are underlying numbers used to generate the private key.

### Process

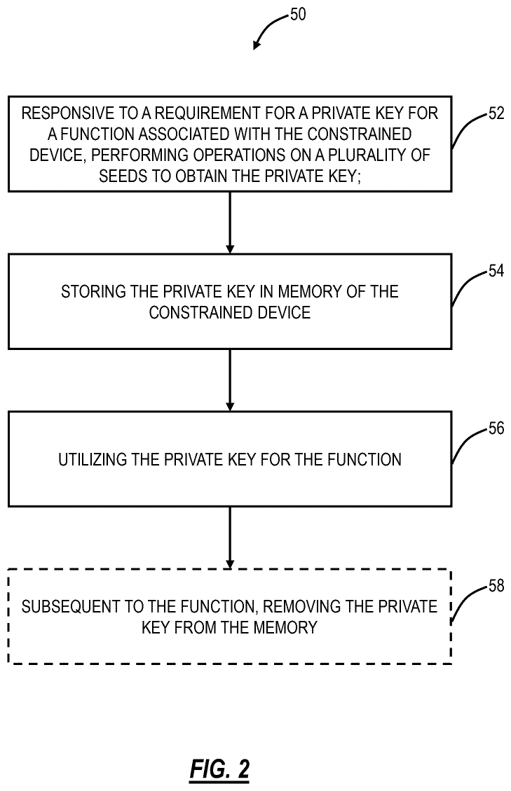

FIG. 2 is a process 50 for generating private keys for quantum-safe algorithms on constrained devices. The process 50 contemplates implementation as a method having steps, via the constrained device 10 configured to implement the steps, and via a non-transitory computer-readable medium storing instructions that, when executed, cause a processor to implement the steps.

The process 50 includes, responsive to a requirement for a private key for a function associated with the constrained device, performing operations on a plurality of seeds to obtain the private key (step 52); storing the private key in memory of the constrained device (step 54); and utilizing the private key for the function (step 56). The process 50 can include, subsequent to the function, removing the private key from the memory (step 58).

The private key is for a quantum-safe algorithm. Advantageously, the process 50 enables support for the quantum-safe algorithm, considering resource constraints in the constrained device, namely fixed memory, processing capabilities, etc. The quantum-safe algorithm can be one of lattice-based, hash-based, code-based, multivariate-based, and isogeny-based. Of note, the process 50 can work with any algorithm that includes some mathematical generation of the private key based on seeds.

The process 50 can include, prior to the requirement for the private key, storing the plurality of seeds in the memory. For example, this can be performed at manufacturing, assembly, etc. It can also be performed in an upgrade, update, etc.

The memory can store the plurality of seeds and logic that defines the operations on the plurality of seeds to obtain the private key. Of note, this differs from the conventional approach where the memory simply stores the private key itself. As noted herein, the private keys for quantum-safe algorithms can take several kilobytes. Assume, e.g., the constrained device has tens or a hundred kilobytes of memory. Storing only the seeds and the logic to create the private key from the seeds can save a significant amount of the memory.

In an embodiment, the constrained device utilizes a non-quantum safe algorithm with an existing private key stored in memory, and, for upgrading the constrained device from using the non-quantum safe algorithm to a quantum safe algorithm, the process 50 includes deleting the existing private key stored in the memory; and receiving and storing the plurality of seeds and associated program code for the operations on the plurality of seeds to obtain the private key. Of note, one use of the process 50 is to upgrade existing constrained devices to support these more complex quantum-safe algorithms.

The function can relate to one of authentication, encrypted communication, enrollment, provisioning, and upgrades. The constrained device can be an Internet-of-Things (IoT) device. The constrained device can be a battery-powered tracker tag.

### Secure Tunnel

As quantum computing technology advances, many legacy devices will be unable to integrate because they lack the computational power. Such legacy devices generally lack the compute power to be resistant to quantum computer attacks. Moreover, traditional cryptographic algorithms such as Rivest-Shamir-Adleman (RSA) and Elliptic Curve Cryptography (ECC) are becoming vulnerable to quantum cryptographic attacks because of the much greater scale of the computational power of quantum computers. Post-Quantum Cryptography (PQC) focuses on developing cryptographic algorithms that are secure against both conventional and quantum computer attacks. As such, the implementation of such can include authentication and session key negotiation in the PQC which involves the use of quantum-resistance algorithms to ensure secure communication. As used herein, the term “quantum-resistance” generally refers to methods and techniques which are substantially resistant to attacks from a quantum computer.

A secure tunnel is one method of transmitting data across an untrusted network, such as the internet. Generally, secure tunnels are configured to encapsulate and encrypt data to protect it from being intercepted or altered. As used herein, the term “tunnel” generally refers to a way data is transmitted through a private or secure connection established between two points, for example between a user device and a server. A secure tunnel can involve encryption, wherein the secure tunnel can encrypt data that ensures that the data is unreadable to anyone who might maliciously intercept the data. Moreover, only the intended recipient can decrypt the data. Secure tunnels can employ authentication, wherein both endpoints (i.e., a user and a server) must authenticate each other. In some aspects, this ensures that the data can only be sent to the correct device. Secure tunnels can encapsulate data, wherein the data can be wrapped in a secure protocol. This can allow the data to pass through networks without being modified. Moreover, secure tunnels are often built using specialized protocols such as Secure Socket Layer/Transport Layer Security (SSL/TLS), IPsec, Secure Shell (SSH), and Virtual Private Networks (VPN)s.

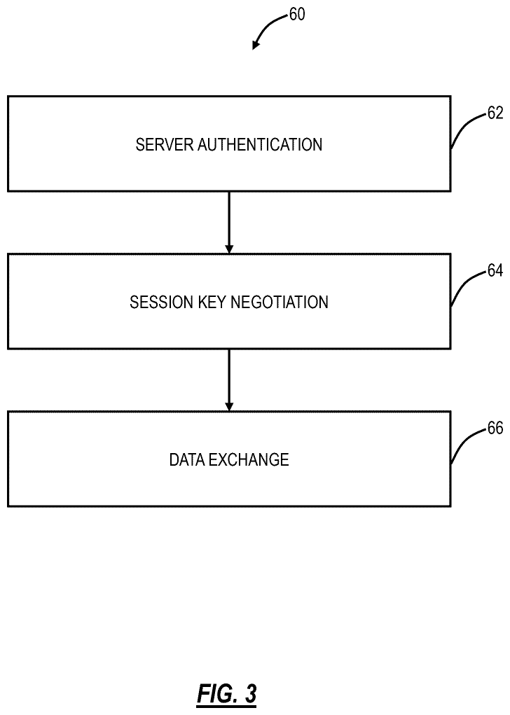

Turning now to FIG. 3, a flowchart of a typical secure tunnel 60 is shown and described. The secure tunnel 60 can be used during a session with, for example, an HTTPS or any other secure protocol (TLS, SSL, etc.) In some aspects, the secure tunnel 60 can include an authentication 62. The authentication 62 can ensure that the server (and optionally the client) is who they claim to be by verifying an identity through a cryptographic certificate. The authentication 62 can present a digital certificate to a client. Such certificate can contain a server's key, such as a public key. The key can be signed by a trusted Certificate Authority (CA). The client can use the CA's public key to verify the server's certificate signature. In some aspects, the CA public key can be pre-signed. More generally, if the certificate is valid and trusted, the server is authenticated in the authentication 62. In other aspects, the authentication 62 can include a mutual TLS. As such, the client can also provide its own digital certificate to authenticate the server. This certificate can be verified by the server with the CA. More generally, mutual authentication can be included in the authentication 62 and can be used in more secure environments, such as corporate networks. In some aspects, the authentication 62 can include a public-key cryptography. This can rely on asymmetric encryption, where the server's or client's identify is verified using a private-public key pair. In such example, the certificate binds the server's public key to its identity (domain, company, etc.)

The secure tunnel 60 can include a session key negotiation 64. The session key negotiation 64 can be used to establish a secure session key that both the client and the server can use for symmetric encryption during a data exchange. In example only the key can be derived using a secrete, such as session-specific data. The session key negotiation 64 can include a RSA key exchange, wherein the client can generate a secret, such as a random value. The client can encrypt the secret using the server's public key and can send the same to the server. The server can decrypt the secret using the private key.

The secure tunnel 60 can include a data exchange 66. The data exchange 66 can be configured to ensure data is transferred between the client in a secure, authenticated, and tamper-resistant manner. The data exchange 66 can include an encryption, wherein after the session key 64 is established, the client and the server use the key to encrypt the data. The data exchange 66 can include symmetric encryption, such as Advanced Encryption Standard (AES) or ChaCha20. In some aspects during the data exchange 66, each data, for example each message, can be encrypted using a cipher suit, for example only and without limitation AES, GCM, or AES-CBC. In certain embodiments, the data exchange 66 can include a record protocol. The record protocol can be configured to divide the data into blocks, which are individually encrypted and transmitted. The data exchange 66 can include symmetric encryption for efficient and secure data exchange. Moreover, each partition of data in the data exchange 66 can include an integrity check to prevent tampering. More generally, the data in the data exchange 66 can be divided into records for transmission, which can ensure confidentiality, integrity, and authenticity.

A more general approach to the secure tunnel 60 can include a client requesting to establish a secure connection with a server or another device, thus defining two endpoints. The two endpoints can authenticate with each other, usually by exchanging keys or certificates. Once authenticated, a tunnel is created wherein the data is sent through the tunnel. The data can be encrypted and pass through the untrusted network via the tunnel. Once the data is received by the opposite endpoint, the data can be decrypted and used as intended. The benefits of the use of the secure tunnel 60 can be increased confidentiality, wherein all the data passing through the tunnel is encrypted which prevents interception, authentication, wherein the data is ensured to be sent and received by the intended source, and privacy, wherein the data is protected from alteration and malicious actors.

### Post-Quantum Cryptography

Post-Quantum Cryptography (PQC) refers to cryptographic algorithms designed to be secure against potential threats posed by quantum computers. Current cryptographic methods, such as RSA and ECC rely on the difficulty of factoring large numbers or solving complicated discrete logarithms. Such tasks are secure because of the raw computational power required to provide a solution. In other words it would take an impractical amount of time to solve these problems. However, quantum computers, which are significantly more computationally powerful than conventional computers, can easily crack these conventional algorithms. PQC does not depend on quantum mechanics itself, but rather a classical cryptographic approach using mathematical problems that are resistant to quantum attacks. These algorithms are based on hard problems like lattice-based cryptography, code-based cryptography, multivariate polynomial cryptography, and hash-based cryptography. As such, the goal of PQC is to ensure that the encryption, digital signatures, and key exchanges remain secure as quantum computing technology becomes more prevalent.

Typical examples of PQC can include digital signature algorithms for the authentication 62, such as CRYSTALS-Dilithium, which is a lattice based algorithm, Falcon SPHINCS, and Key Encapsulation Mechanism (KEMs) for the session key negotiation 64 such as CRYSTALS-Kyber and Classic McEliece. The Cryptographic environment of the PQC can be defined by setting up a cryptographic library, which involves the use of well-established PQC libraries that implement the chosen algorithm and ensuring compliance, wherein the algorithms and implementations are checked for compliance against a standard, such as those from NIST. Authentication can ensure that the parties involved are who they claim to be. The authentication 62 can include a key generation, wherein each party generates a key pair using PQC digital signature algorithms. For example, a private key which is kept secret by the owner and used for signing or a public key which is shared openly or distributed via certificates and used for verification can be created. The authentication 62 can include a certificate creation and exchange. The certificate can bind a public key to an identity using the digital certificate. In some aspects, it is ideal that the digital certificate is issued by a quantum-safe CA. The exchange can include the parties exchanging their certificates to obtain each other's public keys in a secure fashion.

The authentication process can implement a challenge-response mechanism which can utilize the digital signatures. A challenge generation can generate and send a random challenge to the provider. The challenge can be signed by the receiver using the private key. The signature can be verified using the public key extracted from the certificate. In some aspects, mutual authentication can be required. For this, the authentication can be repeated with the roles reversed.

The PQC protocol can include a certificate exchange, wherein certificates containing PQC public keys are exchanged. The PQC protocol can include an authentication, wherein mutual authentications using digital signatures are performed. The PQC protocol can contain session key derivation, wherein both parties derive the same session key from the shared secret. The PQC protocol can include a secure communication, wherein the session key is used for symmetric encryption to protect further communication. In implementation, a TLS protocol can be updated. For example, a PQC algorithm can be integrated into a TLS handshake process. In other aspects, a hybrid approach can be used wherein both classical and PQC algorithms are used during the transition period to maintain compatibility and add security layers. In some implementations, libraries that are optimized for performance to handle the computational demands of PQC can be used. Side-channel protection can be included, wherein countermeasures are implemented against side-channel attacks or power analysis. Testing can be conducted, such as functional, performance, and interoperability analysis to analyze the TLS.

Implementing PQC algorithms can be resource-intensive due to larger key sizes and increased computational complexity. Algorithms should be selected that show favorable performance profiles. Further, hardware that supports PQC can be used to improve performance. Security parameters to balance security requirements and performance needs can be incorporated into the TLS. More generally, the implementation of PQC algorithms in the authentication 62 and the session key negotiation 64 can involve selecting the appropriate PQC algorithm, updating the cryptographic protocols, and security and performance evaluation.

The implementation of the authentication 62 and the session key negotiation 64 based on asymmetric key cryptography in terms of PQC can pose significant challenges for devices with limited computational resources. The primary difficulty results from the larger key sizes and increased computational complexity of PQC algorithms compared to classical cryptographic schemes like RSA or ECC. For example, typical key sizes for RSA can range from 2048 to 4096 bits and 256 to 521 bits for ECC. In PQC, public keys can be several kilobytes in size in lattice based schemes and can be hundreds of kilobytes to megabytes in code-based schemes. As a result, there are impacts on resource-constrained devices such as memory limitations, RAM constraints in devices like microcontrollers, and flash storage. Moreover, buffer management and stack limitations can further constrain devices.

PQC algorithms can often include operations like large matrix multiplications, polynomial arithmetic, and number-theoretic transforms. These operations are exceptionally computationally intensive compared to exponentiation in RSA or point multiplication in ECC. As such, they are often associated with a long execution time, latency, and throughout. Cryptographic operations which take milliseconds to seconds are unacceptable for real-time applications. Also, lower transactions rates due to longer computation times ca degrade system performance. In addition, energy consumption can be an issue. Increased computation can lead to reduced battery life and energy efficiency while prolonged high CPU usage can cause overheating, especially in devices without active cooling. Further still, in cellular networks, increased data transmission can lead to higher operational costs which is important for IoT devices where data plans may be limited. The implementation of PQC algorithms can increase the code size due to complex mathematical libraries. Further, Over-the-Air (OTA) updates can become more challenging due to the larger firmware size can increase the risk of update failure. Real-time systems require operations to compete within the strict time bounds.

In implementations, these PQC algorithms can be implemented on IoT devices. Such examples include smart sensors, which have 8-bit or 16-bit microcontrollers with limited RAM, wearable devices which prioritize low power consumption and have limited capacity to handle computation, sensors, and mobile phones. More generally, implementing PQC authentication 62 and session keys 64 on device with limited compute power is challenging for at least because of larger key sizes, increased computational demand, higher energy consumption, storage constraints, communication overhead, and lack of hardware support.

### Offloading the Protocol

Disclosed herein are methods and systems for offloading computationally intensive stages of TLS for constrained devices, such as IoT devices. Again, the TLS, or more generally the secure tunnel 60 can involve multiple stages, such as the server authentication 62, the key negotiation 64, and the data transmission 66. The present disclosure provides methods to reduce the limitations in CPU, memory, or storage during any of the stages.

One aspect of the present disclosure pertains to offloading these stages to a co-located server within the same network. The offloading can include a server role. The server, for example a Secure Key Service (SKS) can handle the authentication 62 and the key negotiation 64 on behalf of the constrained device. The constrained device can establish a secure connection with the SKS. In some aspects, the server can be within the same network to maintain security and ensure low-latency communications. A server that is in the same network can be a server that shares the same network address space or subnet with other devices within a LAN or a broader network context. In some aspects, after the key negotiation 64, the server can provide the key back to the constrained device. This can allow the device to then proceed to the data transmission stage securely. As such, the server could be a dedicated edge gateway, a modem, or a powerful smartphone that is capable of handing the necessary cryptographic communications. For example, in a home environment, it could be a central hub or smart home controller that manages one or more IoT devices. In further example, in industrial settings, the server could be a dedicated server to processing data from numerous sensors or machinery.

Such offloading can increase resource efficiency. By delegating the compute-heavy process to a more capable server, the constrained devices can function efficiently without needing upgrades or replacements. This approach can be implemented in large enterprises with many existing devices, such as Brownfield devices. As used herein, the term “brownfield device” generally refers to a device or system that operates within an existing infrastructure that may be outdated or not designed for the latest technology standard. In other aspects, the SKS can be updated independently to support newer PQC algorithms without requiring changes to the constrained devices. Moreover, as security needs evolve, the devices can continue to function securely by relying on the updated server. In implementations, since the device communicates directly with the intended destination after session establishment, the method can avoid the overhead of routing data through a proxy server and can reduce latency and potential bottlenecks.

The process can involve pre-shared secrets that both the constrained device and the SKS can possess. Such pre-shared secrets can be configured for secure communication during the initial connection setup. As a result of the communication occurring within a local network, the risk of exposure to outside threats can be reduced. Importantly, the secure channel must still be maintained to prevent eavesdropping or tampering. After the establishment of the session, data can flow directly from the constrained device to its destination which can minimize points of vulnerability compared to a proxy model. More generally, the offloading of the authentication 62 and key negotiation 64 stages of the TLS to a co-located server can allow the constrained devices to maintain secure communication without overburdening their limited resources. This method enhances efficiency, scalability, and security.

The method can include establishing a secure connection between the server and the constrained device. Such secure connection can prevent vulnerabilities, for example and without limitation in the context of TLS security and IoT applications. The method can include the mutual authentication wherein before any sensitive data is exchanged, the server and the constrained device must authenticate each other. This can ensure that both parties are legitimate and can prevent “man-in-the-middle” attacks where an unauthorized entity can intercept data. The method can include certificate validation wherein the server can present a digital certificate to the device. The device can validate the certificate and can verify that the server is who it claims to be. More generally, the method can include defining a trust relationship for secure communications. Establishing a secure connection between the server and the device can safeguard sensitive information. As such, the architecture presented herein can be adapted to enhance security and support operational efficiency by specifically enabling constrained devices to perform critical functions without compromising their integrity.

In some methods, the architecture can shift the role of the server in secure communications away from the traditional proxy model, which typically routes data through a server for both authentication and data transmission. The methods of the disclosure involve servers whose role is strictly to establish a secure session and allow the constrained device (i.e., an IoT device) to maintain a direct communication path with its intended end peer. In example, the server is responsible only for authentication the parties involved and negotiating the session key. The method can include using a PQC algorithm to ensure security against potential future threats. The constrained device can offload the resource-intensive tasks of the authentication 62 and the key negotiation 64. The method can include peer-to-peer data transmission. Such data transmission can, once the session key is established, provide direct communication with the end peer without routing data through the server. This direct connection can reduce latency and increase efficiency as data flows between the two parties. Since the server only establishes sessions and does not relay data, its computational requirement can be significantly lower. This can allow it to manage multiple devices more effectively without becoming a bottleneck. Further, such approach can eliminate the need for the server to handle data transmission and avoid data relays, as the data does not interact or pass through a third party.

In typical aspects, this architecture can allow for easy updates to the cryptographic algorithms used for the authentication 62 and the key negotiation 64. Since the server manages these algorithms, any changes can be implemented without requiring updates to the constrained devices. This is particularly advantageous if there exist brownfield devices in operation. More generally, this architectural approach can optimize server capabilities by confining its role to the session management while enabling constrained devices to interact directly with their peers. As such, security and efficiency are enhanced along with the simplification of the process.

In some aspects, the server can implement the SKS and can be configured to facilitate the authentication 62 and the key negotiation processes 64 for constrained devices that lack the computational resources to handle these tasks. More specifically, the SKS can operate within the same local network as the constrained devices and ensure a secure connection for exchanging sensitive information. The SKS can verify the identity of both the constrained device and the server. The SKS can negotiate a symmetric session key using PQC methods Once the session key is established, the constrained device can securely transmit data directly to its destination without routing through the SKS, which can minimize overhead. The constrained device can bypass the initial two stages of authentication and key negotiation by offloading these responsibilities to the SKS. This approach can be beneficial for low-power IoT devices. Smart appliances, security systems, or home automation devices can use the SKS hosted on a more powerful device like a smartphone, tablet, or dedicated edge gateway and can seamlessly integrate PQC. Again, such architecture is particularly advantageous for brownfield devices already in use which can be integrated into a new security model without needing extensive hardware upgrades. A centralized PQC can be utilized and can be capable of handling PQC to manage all the legacy devices without having to replace them.

Such methods provide advantages over traditional proxy models such as direct communication by enabling direct peer-to-peer communication after session establishment. As such, the system avoids the performance bottleneck associated with proxy servers, which can slow down data transmission and create unnecessary points of failure. Moreover, this architecture allows for easy updates to security algorithms at the SKS level, meaning that if new PQC algorithms are developed, only the SKS needs updating. Constrained devices can continue operating without modification, provided they have the necessary keys.

In aspects, the method provides the flexibility to update PQC algorithms on a centralized server without requiring updates for each constrained device is a significant advantage in the context of IoT device management and security. The SKS can be implemented on an in-network centralized server that can handle the more demanding tasks, such as the authentication 62 and the key negotiation 64. The server establishes the session key on behalf of the constrained device, allowing it to focus on its primary functions without being burdened by complex computations. After the SKS negotiates and provides the session key to the constrained device, the device can use this key for secure communications. Importantly, this operation does not require any updates to the device itself, meaning it can continue to function normally without interruption.

If a new PQC algorithm is developed or needed (e.g., due to advancements in quantum computing or security vulnerabilities), the centralized server can be updated to implement this new algorithm without having to modify or replace the constrained devices. The key aspect is that once the session key is negotiated, the constrained device can communicate using that key regardless of the specific algorithm used for its establishment. This ensures that devices remain secure and operational even as algorithms evolve.

### Method

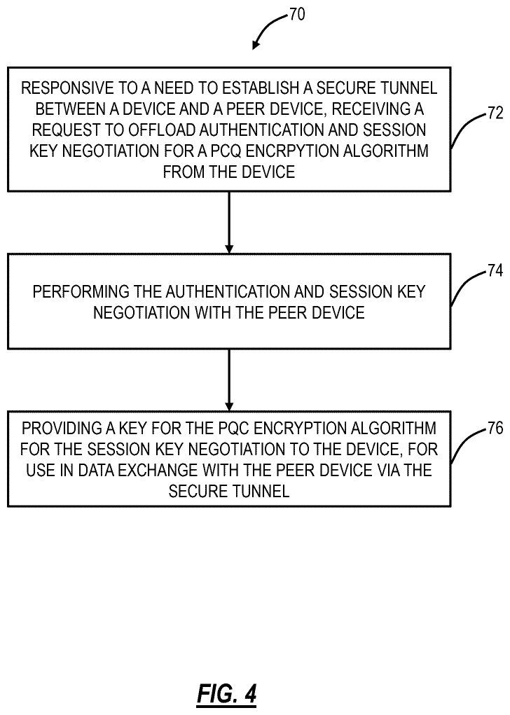

Turning now to FIG. 4, a method 70 for offloading a secure communication transport protocol session key negotiation and establishment to a remote server is shown and described. The process can be performed via an SKS. The method can include responsive to a need to establish a secure tunnel between a device and a peer device, receiving 72 a request to offload authentication and session key negotiation for a PQC encryption algorithm from the device. The method can include performing 74 the authentication and session key negotiation with the peer device. The method can include providing 76 a key for the PQC encryption algorithm from the session key negotiation to the device, for use in data exchange with the peer device via the secure tunnel. In some aspects the method 70 can include wherein the device has constraints in any of: compute power, storage, and memory for performing the authentication and session key negotiation in the PQC algorithm. In some aspects, the method 70 can include wherein the device is an Internet of Things (IoT) device. The IoT device can be, without limitation, smart devices, cameras, alarms, smoke detectors, smart wearables, smart weather stations, smart appliances such as smart ovens or smart refrigerators, smart sensors, connected machinery, fleet tracking devices, smart agriculture devices, smart TVs, and smart assistants.

The method 70 can include wherein the device and the SKS are on a same network. The method 70 can include wherein the device and the SKS communicate securely with one another via a non-PQC encryption algorithm. For example, the method 70 can employ a conventional encryption or a hybrid encryption. The method 70 can include wherein the device and the SKS communicate securely with one another via a pre-shared secret. The method 70 can include wherein the PQC encryption algorithm is a first algorithm, and wherein the method further comprises charging to a second PQC encryption algorithm at the SKS independent of the device.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms “comprise,” “comprises,” “comprising,” “include,” “includes,” and “including” are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing are contemplated. Furthermore, the separation of system components described should not be interpreted as mandatory for all implementations, as the program components and systems can be integrated into a single software product or distributed across multiple software products.

What is claimed is:

1. A method performed via a Security Key Service (SKS) comprising:
responsive to a need to establish a secure tunnel between a device and a peer device, receiving a request to offload authentication and session key negotiation for a Post-Quantum Cryptography (PQC) encryption algorithm from the device;
performing the authentication and session key negotiation with the peer device; and
providing a key for the PQC encryption algorithm from the session key negotiation to the device, for use in data exchange with the peer device via the secure tunnel.

2. The method of claim 1, wherein the device has constraints in any of: compute power, storage, and memory for performing the authentication and session key negotiation in the PQC algorithm.

3. The method of claim 1, wherein the device is an Internet of Things (IoT) device.

4. The method of claim 1, wherein the device and the SKS are on a same network.

5. The method of claim 1, wherein the device and the SKS communicate securely with one another via a non-PQC encryption algorithm.

6. The method of claim 1, wherein the device and the SKS communicate securely with one another via a pre-shared secret.

7. The method of claim 1, wherein the PQC encryption algorithm is a first algorithm, and wherein the method further comprises:
charging to a second PQC encryption algorithm at the SKS independent of the device.

8. A method performed at a device comprising:
responsive to a need to establish a secure tunnel between the device and a peer device, requesting to offload authentical and session key negotiation for a Post-Quantum Cryptography (PQC) encryption algorithm from the device to a Security Key Service (SKS);
responsive to the SKS performing the authentication and session key negotiation with the peer device, receiving a key from the PQC encryption algorithm; and
exchanging data with the peer device over the secure tunnel using the key.

9. The method of claim 8, wherein the device has constraints in any of: compute power, storage, and memory for performing the authentication and session key negotiation in the PQC algorithm.

10. The method of claim 8, wherein the device is an Internet of Things (IoT) device.

11. The method of claim 8, wherein the device and the SKS are on a same network.

12. The method of claim 8, wherein the device and the SKS communicate securely with one another via a non-PQC encryption algorithm.

13. The method of claim 8, wherein the device and the SKS communicate securely with one another via a pre-shared secret.

14. The method of claim 8, wherein the PQC encryption algorithm is a first algorithm, and wherein the method further comprises:
charging to a second PQC encryption algorithm at the SKS independent of the device.

15. A Security Key Service (SKS) system comprising:
a processor; and
a memory storing program code that is configured to cause the processor to:
responsive to a need to establish a secure tunnel between a device and a peer device, receive a request to offload authentication and session key negotiation for a Post-Quantum Cryptography (PQC) encryption algorithm from the device;
perform the authentication and session key negotiation with the peer device; and
provide a key for the PQC encryption algorithm from the session key negotiation to the device, for use in data exchange with the peer device via the secure tunnel.

16. The SKS system of claim 15, wherein the device has constraints in any of: compute power, storage, and memory for performing the authentication and session key negotiation in the PQC algorithm.

17. The SKS system of claim 15, wherein the device is an Internet of Things (IoT) device.

18. The SKS system of claim 15, wherein the device is on a same network as the SKS system.

19. The SKS system of claim 15, wherein the device and the SKS system communicate securely with one another via a non-PQC encryption algorithm.

20. The SKS system of claim 15, wherein the device and the SKS system communicate securely with one another via a pre-shared secret.
